(19) United States
(12) Patent Application Publication
(10) Pub. No.: US 2015/0213754 A1
(43) Pub. Date: Jul. 30, 2015

(54) HIGH EFFICIENCY BEAM COMBINER COATING

(71) Applicant: eMagin Corporation, Hopewell Junction, NY (US)

(72) Inventor: Malik I. Amjad, Hopewell Junction, NY (US)

(21) Appl. No.: 14/606,977

(22) Filed: Jan. 27, 2015

Related U.S. Application Data
(60) Provisional application No. 61/931,971, filed on Jan. 27, 2014.

(51) Int. Cl. G09G 3/32

(52) U.S. Cl. CPC G09G 3/3208; G09G 2320/0238; G09G 2340/10

(57) ABSTRACT

A system having an improved optical coating for use in beam combiner assemblies for an image fusion device using an organic light-emitting diode (OLED) display. The system combines multi-spectral images of a scene having superior reflection of the OLED display image while incorporating high transmission of the image fusion device while allowing low power requirements on the system.

### CROSS-REFERENCE TO RELATED APPLICATION

This application claims priority to U.S. Provisional Patent Application Ser. No. 61/931,971, entitled “High Efficiency Beam Combiner Coating for OLED Display Image Fusion”, filed in the United States Patent and Trademark Office on Jan. 27, 2014, the entire disclosure of which is incorporated by reference herein.

### BACKGROUND OF THE INVENTION

1. Field of the Invention

This invention relates generally to image fusion systems employing an organic light emitting diode (“OLED”) display with which to fuse images from different spectral channels, and more particularly, to a system having an improved optical coating for use in beam combiner assemblies for an image fusion device using an organic light-emitting diode (OLED) display. The system combines multi-spectral images of a scene having superior reflection of the OLED display image while incorporating high transmission of the image fusion device while allowing low power requirements on the system.

2. Description of the Related Art

OLED technology uses an organic compound to produce light when power is applied. OLEDs produce their own light, and there is therefore no need for additional back-lighting as with LCD systems. True black can be achieved by turning off the current to a given element, whereas only dark grey is possible in back-lit systems. As a result, OLED displays naturally offer a vast improvement in sharpness and contrast.

OLED micro-displays that are Solid State rely on fewer components to minimize power consumption and dissipation, and the likelihood of failure. Fabricating the OLED micro-display onto the circuitry that controls and processes the video signal, results in a minimal package with increased reliability, ruggedness, and efficiency. Each OLED can produce nearly the entire spectrum of visible light. Microscopic red, green, and blue filters are overlaid and can be selectively combined to produce any color. There are millions of elements per display, which combine to produce over 16.7 million colors.

Data for each OLED element is buffered right at the pixel location so the duration between changes for the element is as fast as possible. The result is a very fast response time and no image jitter. The image is crisp and sharp, and user eye-fatigue is greatly reduced. Image fusion is the process of combining relevant information from two or more images into a single image. The resulting image is thereby more informative than any of the input images. Several situations in image processing require high spatial and high spectral resolution in a single image. However, most of the available equipment is not capable of providing such data convincingly. Image fusion techniques allow the integration of different information sources. The fused image can have complementary spatial and spectral resolution characteristics, but the standard image fusion techniques can distort the spectral information of the multispectral data while merging.

Image fusion devices employ the fusing of images from different. spectral channels and traditionally utilize a broadband beam combiner. A beam combiner is one such image fusion device and is configured to generate a combined image by combining a first image and a second image, and transmit the combined. image to a user. Beam combiners are partial reflectors that combine two or more wavelengths of light, one in transmission and one in reflection, onto a single beam path. The broadband beam combining optical coating is typically optimized to transmit a high percentage of light from the night imagery channel. This results in the optical coating reflecting a lower amount of light from the image that is being overlaid, thus requiring the overlay image generation device to be driven with greater electrical power. At the same time, the preferred operation of the image fusion device relies on a large exit pupil of the optical system, which sets the coating properties to extend over large Angle of Incidences at the coating interface.

Spectral beam combining (also called wavelength beam combining or incoherent beam combining) does not require mutual coherence, but rather uses emitters with non-overlapping optical spectra. The single beams are then fed into a wavelength-sensitive beam combiner, such as a prism, a diffraction grating, adichroic mirror, or a volume Bragg grating.

Night vision devices are commonly used by military or law enforcement personnel for conducting operations in low light or night conditions. Night vision devices may include one or more image sources for providing an enhanced image to the user. It may be desirable to provide internal indicator lights on the night vision device to indicate the status of the one or more image sensors or illuminators. There exists a need for an improved approach to visually inform the user of the status of his night vision device.

It is, therefore, a primary object of the present invention to provide a system, which maximizes the reflectance of light from the OLED display while simultaneously maintaining high transmission of the image fusion device.

It is another object of the present invention to provide an optical coating having a high transmission band corresponding to the spectral properties of the image fusion device.

It is another object of the present invention to provide a system having an improved optical coating for use in beam combiner assemblies for an image fusion device using an organic light-emitting diode (OLED) display.

It is another object of the present invention to provide an image fusion device whereby the emission spectra is transmitted with virtually no loss in intensity.

It is another object of the present invention to provide a system OLED display image fusion device that utilizes minimal power requirements but maintains bright imagery.

It is another object of the present invention to provide an image fusion device, which may be a night vision device.

### BRIEF SUMMARY OF THE INVENTION

In accordance with one aspect of the present invention, a system is provided for combining multi-spectral images of a scene. The system includes a channel for transmitting a scene image in a first spectral band in a first optical path, and a separate second detector for sensing the scene in a second spectral band in a second optical path. The second detector has an image output representative of the scene. The system includes a display for receiving the image output of the second detector, and displaying an image from the second spectral band, the display includes a transparent organic light-emitting diode (OLED). The system includes a beam mixer for combining the scene image in the first spectral band with the displayed image, and conveying the combined multi-spectral images to an output. The mixer includes means for transmitting unattenuated the scene image in the first spectral band while simultaneously maximizing reflectance of light from the display. The reflectance of light of the system averages over at least 50%. The means of the beam mixer is a high efficiency coating for transmitting unattenuated the scene image in the first spectral band while simultaneously maximizing reflectance of light from the display.

In accordance with an additional embodiment, a beam combiner assembly for an image fusion device using an organic-light emitting diode (OLED) display is provided. The image fusion device emits spectral bands of light, and the OLED display emits a spectrum of visible light having spectral proprieties. The assembly includes means configured to generate a combined image by combining a first image from a first imager and a second image from a second imager, the means is further configured to transmit the combined image to the OLED display. The assembly includes means for minimizing overlap of wavelengths between the bands of light emitted from the image fusion device and the OLED display.

The means for minimizing overlap of wavelengths between the bands of light emitted from the image fusion device and the OLED display is an optical coating.

The optical coating includes means for optimizing reflectance response of the OLED display in the visible spectrum. The reflectance response of the OLED display is at least 50%.

The OLED display has a spectral emission pattern with minimum emission at the same wavelength as maximum emission of the image fusion device.

In accordance with an additional embodiment, an optical coating for use in bean combiner assemblies is provided that uses an organic-light emitting diode (OLED) display with which to fuse images derived from different spectral channels. The coating includes means for transmitting unattenuated a first image derived from a first spectral channel while simultaneously maximizing reflectance of light from the OLED display. The reflectance of light from the OLED display is at least 50%.

### BRIEF DESCRIPTION OF THE SEVERAL VIEWS OF THE DRAWINGS

To these and to such other objects that may hereinafter appear, the present invention relates to a system having an improved optical coating for use in beam combiner assemblies for an image fusion device using an organic light-emitting diode (OLED) display as described in detail in the following specification and recited in the annexed claims, taken together with the accompanying drawings, in which like numerals refer to like parts in which:

FIG. 1 is a block diagram of a prior art system having a standard coating for use in beam combiner assemblies for image fusion devices using displays;

FIG. 2 is a block diagram of a system of the preferred embodiment of the present invention, having an improved optical coating for use in beam combiner assemblies for an image fusion device using an organic light-emitting diode (OLED) display;

FIG. 3 is a plot, showing percent transmittance of optical coating response of the beam combiner assembly in accordance with the system of the present invention shown in FIG. 2;

FIG. 4 is a plot showing percent transmittance of the standard coating response of a standard beam combiner in accordance with the prior art;

FIG. 5 is a plot showing percent transmittance of the improved coating response of the improved beam combiner assembly of the preferred embodiment of the present invention in accordance with FIG. 1;

FIG. 6 is a plot showing percent spectral response of the OLED display and the image fusion. device;

FIG. 7 is a plot showing percent resultant response of the OLED reflected light and the high response of the transmitted light from the high efficiency coating in accordance with the preferred embodiment of the present invention; and

FIG. 8 is a plot showing the CIE coordinates of the OLED display white light and the OLED display white light as reflected from the high efficiency coating in accordance with the present invention.

To the accomplishment of the above and related objects the invention may be embodied in the form illustrated in the accompanying drawings. Attention is called to the fact, however, that the drawings are illustrative only. Variations are contemplated as being part of the invention, limited only by the scope of the claims.

### DETAILED DESCRIPTION OF THE INVENTION

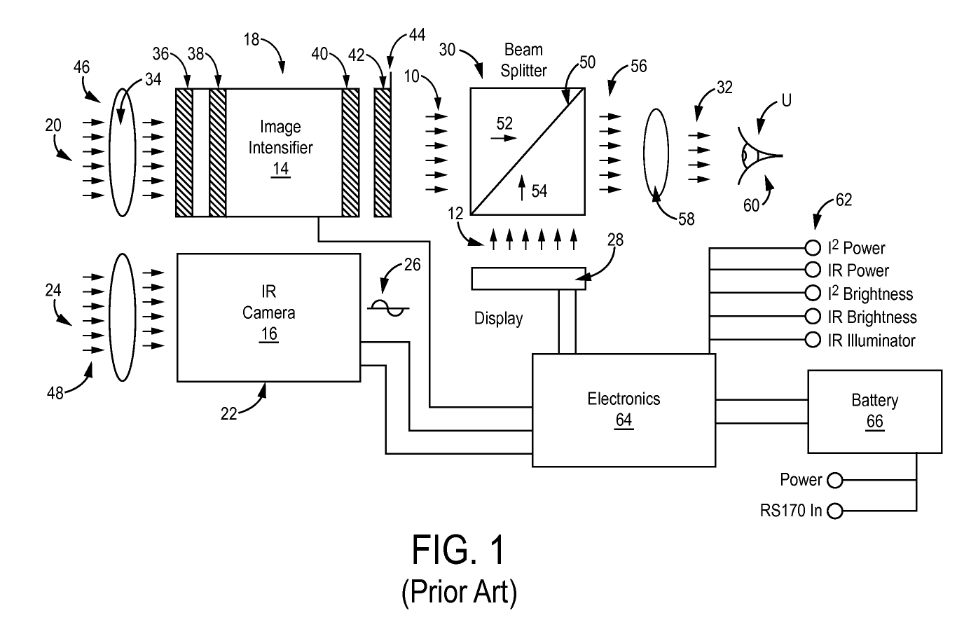

FIG. 1 illustrates the prior art, which describes a night vision system 8 or device that provides fusion of two images 12 originating from an image intensifier 14 and an infrared camera 16.

The system 8 for combining multi-spectral images of a scene includes a first channel or detector 18 for transmitting a scene image 20 in a first spectral band. A separate, second detector 22 senses the scene 22 in a second spectral band. The second detector 22 has an electronic signal image output 26 that is representative of the scene 22. A display 28 displays an image 12 in the second spectral band. A beam mixer 30 combines the image output 10 in the first spectral band with the displayed image 12, and conveys the combined multi-spectral images to an output 32 for a user U.

The image intensifier 14 provides an imager using known photo-cathode, multi-channel plate, and phosphor screen technology. Visible and near infrared light is collected by an optical element (objective) 34 and is focused onto the photo-cathode 36, where photons are converted to electrons. The electrons are accelerated through the multi-channel plate 38, creating new electrons. The resultant multiplication of electrons land on a phosphor screen 40 where luminescence occurs. The image created 10 is passed through a fiber optic bundle 42 creating an optical imaging focal plane 44.

A known infrared camera 16 is used to convert infrared imagery into a visible image. Since the present invention can utilize any type of infrared camera, the description of converting infrared imagery into a visible image is not set out here. However, it is important that the output of the infrared camera is provided in a form that can be formatted for projection onto a display.

Preferably, the incoming path 46 for collecting incoming radiant energy for the image intensifier is separate from, but essentially parallel, to the incoming path 48 for the infrared camera.

A known, standard image intensifier 14 optical design is used with an additional beam mixer or splitter 30 component. The beam mixer 30 is a device that allows two optical channels to be combined. Using the inventive coating 50 two optical paths, which originate perpendicular to one another, are combined and 50% of the incident radiation is permitted to be reflected. In a preferred embodiment, the image intensifier's output 10 is positioned adjacent to the beam mixer/splitter 30 and is oriented in the optical path 52 that corresponds to the 50% transmission through the beam mixer. The display 28 is positioned adjacent to the beam mixer 30, is oriented in the optical path 54 that corresponds to the 50% average reflection, and is perpendicular to the image intensifier path 52.

The two images 10, 12 are projected through the beam mixer 30 optical path where a combined (fused) image 56 is provided as an output of the beam splitter 30.

An optical lens (eyepiece) 58 provides the ability to focus on the beam mixer/splitter providing the combined image to a user's eye 60.

The final product of the prior art assembly results in a fused multi-spectral optical overlay image.

The inventive coating 50 of the beam splitter is generally placed on the 45-degree surface that allows the two optical paths to be combined. The night vision goggle's (NVG) optics provides an equivalent optical path through the eyepiece to the image intensifier and through the eyepiece to the display.

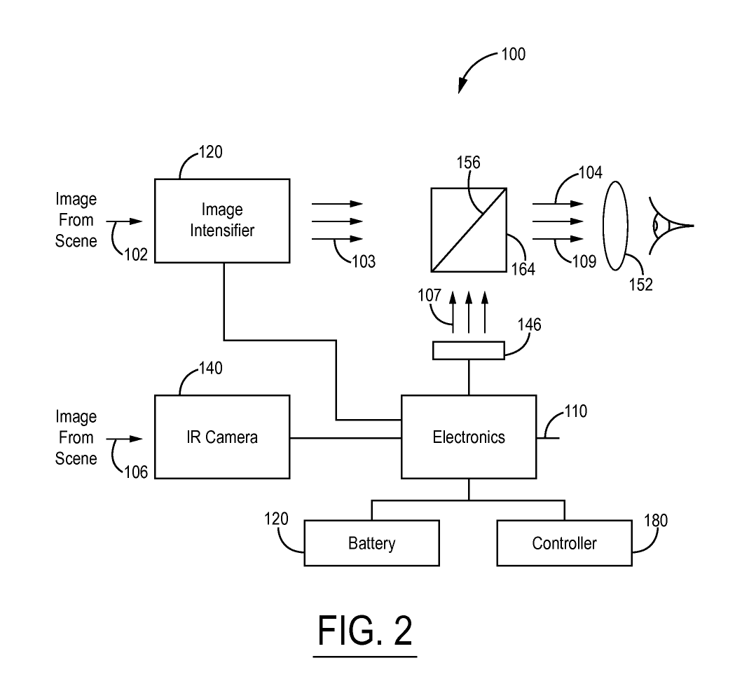

Referring to FIG. 2, the image intensifier 120 includes an objective lens assembly configured to focus visible and near infrared light from a sensed image 102 onto an image intensifier tube. The image intensifier tube is preferably a known I² tube, which generally includes a photo-cathode that converts the light photons to electrons, a multi-channel plate that accelerates the electrons and a phosphor screen that receives the accelerated electrons and creates a luminance in response to the accelerated electrons. The image created by image intensifier 120 is directed along an image intensified input path, as indicated by arrow 103, to a beam splitter 164. The beam splitter 164 may combine and/or split received beams, as will be described in more detail hereinafter, but is referred to herein as a beam splitter. The user display optics 152 are substantially co-axial with the image intensifier 120 and the beam splitter 164, but instead may be offset with a non-linear optics path defined therebetween. Image intensifier 120 is preferably a late model version such as referred to in the art as Generation III, or a later model when such becomes available. If desired, an earlier model, such as a Generation II, may be used.

While the second channel sensor may be any suitable sensor, for purposes of the present disclosure, the second channel sensor will be described as the infrared camera 140. The infrared camera 140 is used to convert infrared imagery into a visible image. The infrared camera 140 may be based on an uncooled focal plane array (FPA) and incorporates its own objective lens, which is designed to provide a thermal video field of view that is essentially the same as the field of view of the image intensifier 120. The optical axes of infrared camera 140 and image intensifier 120 are aligned generally parallel to each other during assembly. The objective lens focuses the infrared image 106 on to a thermal sensor, which outputs a signal indicative of the image. A system electronics 110 receives the output signal from the thermal sensor and projects the image onto a display 146. The display 146 is configured to provide an infrared image along a camera output path 107 to the beam splitter 164 at a substantially right angle relative to the path of the image intensifier image 103.

The display 146 can have various configurations, for example, an emissive type, reflective type, or transmissive type. An emissive type is preferred for the present application since it offers the smallest package and consumes the least power, although reflective and transmissive type displays are encompassed herein. Emissive displays include electroluminescent displays, vacuum fluorescent displays, field emissive displays and OLEDS (organic LED's). As the name implies, the emissive source emits light and does not require a separate light source.

An Organic Light Emitting Diode (OLED) may be used to project the digitized IR camera data. The OLED device provides a robust, integrated design that requires minimal power, and does so under a full military type temperature range. Other known types of displays often either lose performance as the ambient temperature is lowered or require a heating element to keep its temperature at acceptable levels to meet performance requirements. The use of the OLED in the NVG is ideal for minimizing power, which is critical and rationed for extended battery life, across the full NVG operational temperature ranges.

The OLED's format and size is designed so that when projected through the beam splitter, the image intensifier's output circumscribes the display's rectangular format. This allows the fused image to reside in the central portion of the user's field of view. An alternative is considered whereas the image intensifier's output is inscribed in the display.

The inventive coating is based upon the inherent spectral properties of the OLED display and substantially improves the reflection of light from the OLED display image while simultaneously maintaining the high transmission of the beam mixer. The higher reflectance in turn allows the OLED display to consume even lower power in order to provide the same brightness as with a standard coating.

The beam splitter 164 includes the inventive coating 156 that is configured to control passage of the image intensifier image 103 and the infrared camera video image along the camera output path 107 through the beam splitter 164. The inventive coating 156 allows a predetermined percentage of light incident thereon to pass through while reflecting the remainder of the light. In the present embodiment, the inventive coating 156 is configured to allow approximately on average 50% percent of the light incident thereon to pass through while the remaining 50% percent is reflected. As such, approximately 50% percent of the image intensifier image 103 passes through the beam splitter 164 toward the user display optics 152, along a visual lens output path, as indicated by arrow 104, while a remaining percentage, in this case, approximately 50% percent, is reflected away from the user display optics.

Similarly, a percentage of, in this case, approximately 50% percent, of the video display image along the camera output path 107 reflects off the inventive coating 156, as indicated by the arrow 109, and combines with the passed through portion 104 of the intensifier image.

Mathematically speaking, the percentage of light incident on the inventive coating 156 that passes through the coating 156 may be “x” percent, while a remaining percentage, “(100−x)” percent, is reflected. The percentage of the video display image along the camera output path 107 that passes through the dichroic surface 56 is also “x” percent, while a remaining percentage, “(100−x)” percent, is reflected.

The combined images 104 and 109 are directed along a visual lens output path toward the user display optics 52. The user display optics 152 provide the user with the ability to focus on the beam splitter 164 such that the combined image is provided to the user's eye.

The system electronics 110 are associated with the image intensifier 120, the infrared camera 140 and the video display. The system electronics 110 are also associated with a battery 120 and a controller 180. The battery 180 supplies power to each of the components of the system 100. Alternatively, the camera assembly 160 may have an independent power supply. The controller 180 is configured to control the image intensifier 120 and the infrared camera 140 and may also be configured to control the camera assembly 160. Alternatively, the camera assembly 160 may have an independent control assembly.

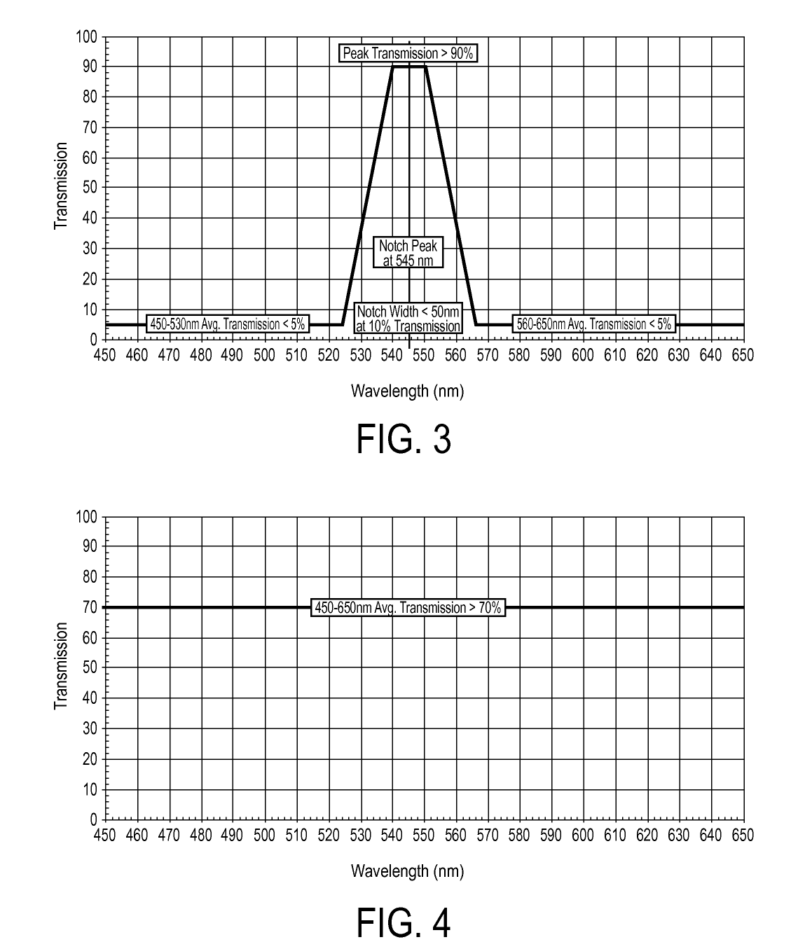

FIG. 3 illustrates pi showing percent transmittance of the optical coating response of the beam combiner assembly in accordance with the system of the present invention shown in FIG. 2.

FIG. 4 is a plot showing percent transmittance of the standard coating response of a standard beam combiner in accordance with the prior art. As seen from FIG. 4, the reflectance response in an existing image fusion device is on the order of only 30% due to the simple nature of the broadband coating that is designed to transmit 70% over the full visible spectral band. Such design is very inefficient. since the image fusion device emits only a narrow spectral band of light, as shown in FIG. 6. A natural improvement is to design the coating to transmit only in the same region as corresponding to the emission characteristics of the image fusion device as shown in FIG.

However, display devices other than the OLED reflect poorly on account of the spectral properties.

The transmission properties of the coating of the present invention. are such that the spectral emission from the image fusion device is minimally attenuated, allowing the device to operate at lower power.

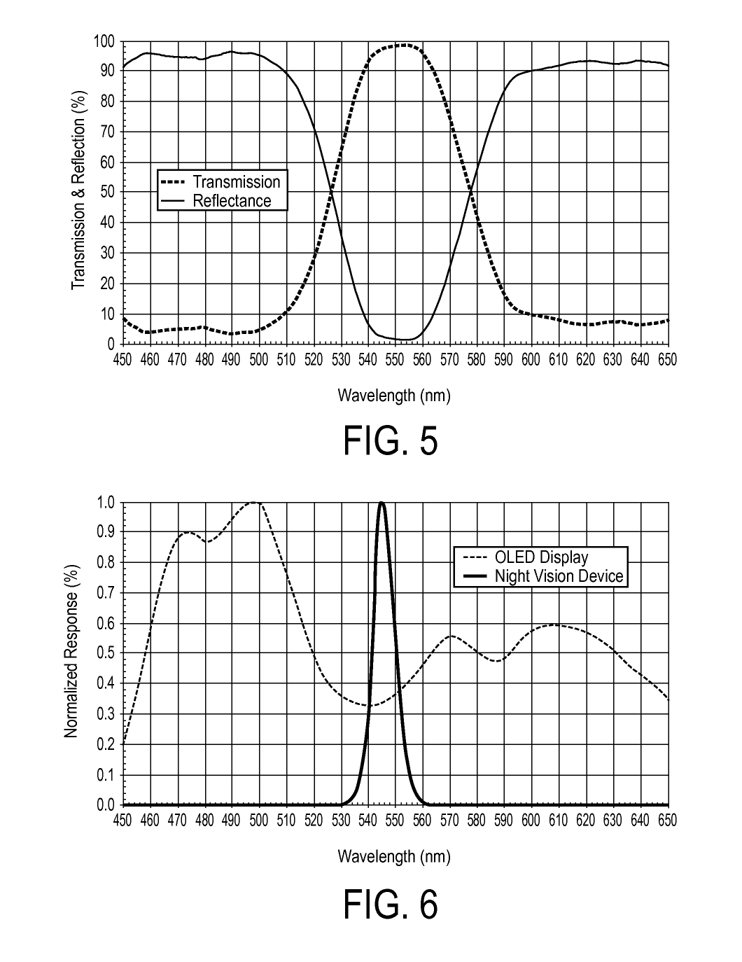

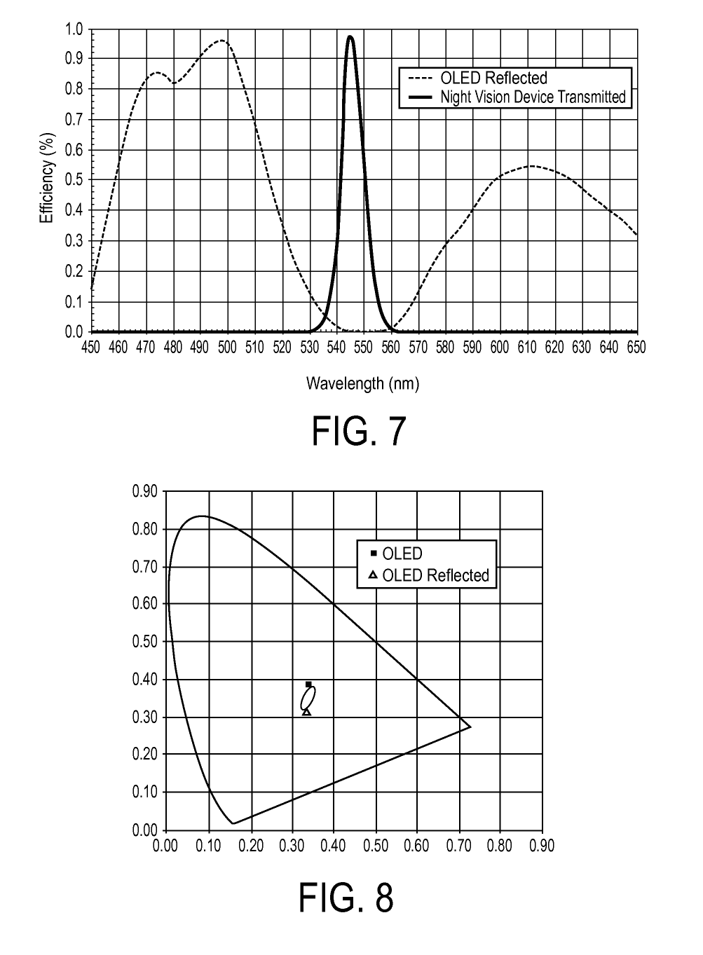

FIG. 5 is a plot showing percent transmittance of he improved coating response of the improved beam combiner assembly of the preferred embodiment of the present invention in accordance with FIG. 1. Using eh coating response for this high efficiency coating as shown in this figure, the resultant reflectance averages to over 50% as shown in FIG. 7, compared to only 30% with the standard coating. The higher reflectance in turn allows the OLED display to consume even lower power in order to provide the same brightness as with the standard coating.

FIG. 6 is a plot showing percent spectral response of the OLED display and the image fusion device. The OLED spectral emission as shown in this figure together with that of the image fusion device, allows the design of this special coating since there is minimal overlap of wavelengths between the image fusion device and the OLED display. The OLED has a spectral emission pattern where there is minimum emission exactly at the same wavelength as the maximum. emission of the image fusion device.

FIG. 7 is a plot showing percent resultant response of the OLED reflected light and the high response of the transmitted light from the high efficiency coating in accordance with the preferred embodiment of the present invention.

FIG. 8 is a plot showing the CIE coordinates of the OLED display white light and the OLED display white light as reflected from the high efficiency coating in accordance with the present invention.

In summary, This invention improves the reflection of the light from the OLED display while simultaneously maintaining the high transmission of the image fusion device, by utilizing a specialized coating based upon the inherent spectral properties of the OLED display. The coating has a high transmission band corresponding to the spectral properties of the image fusion device. All remaining wavelengths are reflected from the coating with a high reflectance coefficient. The variation of the coating response due to the change in the Angle of Incidence is mitigated by realizing that the response is asymmetrically averaged over the area of exit pupil, with a greater emphasis on the central portion of the exit pupil than on periphery.

Although the invention is illustrated and described herein with reference to specific embodiments, the invention is not intended to be limited to the details shown. Rather, various modifications may be made in the details within the scope and range of equivalents of the claims and without departing from the invention.

It will now be appreciated that the present invention relates to a beam combiner assembly for an image fusion device using an organic-light emitting diode display. The invention is illustrated by example in the drawing figures, and throughout the written description.

It should be understood that numerous variations are possible, while adhering to the inventive concept. Such variations are contemplated as being a part of the present invention.

While only a limited number of preferred embodiments of the present invention have been disclosed for purposes of illustration, it is obvious that many modifications and variations could be made thereto. It is intended to cover all of those modifications and variations, which fall within the scope of the present invention as defined by the following claims.

I claim:

1. A system for combining multi-spectral images of a scene, the system comprising:
a channel for transmitting a scene image in a first spectral band in a first optical path;
a separate second detector for sensing the scene in a second spectral band in a second optical path, the second detector having an image output representative of the scene;
a display for receiving the image output of the second detector, and displaying an image from the second spectral band, the display includes a transparent organic light-emitting diode (OLED); and
a beam mixer for combining the scene image in the first spectral band with the displayed image, and conveying the combined multi-spectral images to an output, wherein the mixer includes means for transmitting unattenuated the scene image in the first spectral band while simultaneously maximizing reflectance of light from the display.

2. The system of claim 1 wherein the reflectance of light averages over at least 50%.

3. The system of claim 1 wherein the means of the beam mixer is a high efficiency coating for transmitting unattenuated the scene image in the first spectral band while simultaneously maximizing reflectance of light from the display.

4. A beam combiner assembly for an image fusion device using an organic-light emitting diode (OLED) display, wherein the image fusion device emits spectral bands of light, and the OLED display emits a spectrum of visible light having spectral proprieties, comprising:
means configured to generate a combined image by combining a first image from a first imager and a second image from a second imager, said means further configured to transmit said combined image to said OLED display; and
means for minimizing overlap of wavelengths between the bands of light emitted from the image fusion device and the OLED display.

5. The assembly of claim 4, wherein the means for minimizing overlap of wavelengths between the bands of light emitted from the image fusion device and the OLED display is an optical coating.

6. The assembly of claim 5, wherein the optical coating includes means for optimizing reflectance response of the OLED display in the visible spectrum.

7. The assembly of claim 6, wherein the reflectance response of the OLED display is at least 50%.

8. The assembly of claim 5, wherein the OLED display has a spectral emission pattern with minimum emission at the same wavelength as maximum emission of the image fusion device.

9. An optical coating for use in bean combiner assemblies that use an organic-light emitting diode (OLED) display with which to fuse images derived from different spectral channels, comprising:
means for transmitting unattenuated a first image derived from a first spectral channel while simultaneously maximizing reflectance of light from the OLED display.

10. The coating of claim 9 wherein the reflectance of light from the OLED display is at least 50%.
